(19) United States
(12) Patent Application Publication
(10) Pub. No.: US 2011/0292456 A1
(43) Pub. Date: Dec. 1, 2011

(54) Broken fax document recombining system

(75) Inventors: Sahadevasangary Gajadevasangary, Stevenage (GB); Martin Roantree, Brookmans Park (GB); Alex Cheshire, St. Albans (GB)

(73) Assignee: Xerox Corporation, Norwalk, CT (US)

(21) Appl. No.: 12/789,511

(22) Filed: May 28, 2010

(51) Int. Cl. H04N 1/32

(52) U.S. Cl. 358/405

(57) ABSTRACT

A system and a method of processing faxes are disclosed. The method includes receiving image data that includes a plurality of pages to be transmitted by a first fax device coupled to a fax transmission network. Page number information is encoded in a field of a fax transmission. The fax transmission, including the image data and encoded page number information, is transmitted to a second fax device coupled to the fax transmission network. Whether all pages of the fax transmission are received is determined, based on the transmitted page number information. When fewer than all pages of the fax transmission are received, the received pages of the image data are withheld at the second fax device. When all pages have been received, the pages are concatenated for printing without interruption.

### BACKGROUND

The embodiments described herein relate generally to facsimile machines, also known as fax machines, or multifunction machines which incorporate them, and more particularly to a system and method of processing incoming and outgoing faxes.

Faxing information has proven to be a simple and useful way of sending the information across long distances, while ensuring the integrity of the information being sent. As a result, a large number of faxes are sent and received daily. Each fax contains the information to be printed by the receiving fax device (the image data) as well as address information which the user, or the fax device itself, can enter in various prescribed fields. In addition to a field which is used to uniquely identify the receiving fax device (e.g., by its telephone number) other fields are also provided. These sub-address fields allow, for example, the sender to specify a destination sub-address box at the receiving fax device where the incoming fax will be stored or to send a password for accessing the fax at the receiving fax device. The use of the sub-address fields is optional and thus they are generally left empty.

An Internet facsimile (I-Fax) apparatus is one example of a fax device and is provided with functions of converting image data to a file and transmitting/receiving it over a computer network, a typical example of which is the Internet. The Internet facsimile apparatus is capable of carrying out usual facsimile communications over a Public Switched Telephone Network (PSTN), and therefore it also can function as apparatus connected between a computer network and PSTN.

It is known that during fax communications, line quality issues can cause the fax communication to be dropped. Sending fax devices can resolve this issue by determining which pages have not been successfully received and resending the remaining pages several minutes later. A busy fax receiver can receive several faxes from other senders during this period of time, in particular, if it is so busy that the resending machine cannot get through on its first retry. As a result, incomplete and fragmented fax printouts may become lost or difficult for the user to find in amongst the other fax document received and printed.

Thus, it is desirable therefore to establish a fax protocol to provide an indication of the document size at the beginning of the fax transmission.

### INCORPORATION BY REFERENCE

The following references, the disclosures of which are incorporated herein in their entireties by reference, are mentioned:

U.S. Patent Application Publication No. 2004/0051899, entitled IMAGE PROCESSING DEVICE AND AUTOMATIC PRINTING RESTRICTION AND CONTROL METHOD AND DOCUMENT RECEPTION CONTROL METHOD, published on Mar. 18, 2004, to Saitoh, et al., discloses an automatic printing restriction and control method for an image processing device that comprises a facsimile communication unit capable of handling plural communication methods including facsimile communications via Internet, and prints out documents received by the facsimile communication unit. The method includes presetting whether or not automatic printing of received documents is to be implemented, separately with respect to each of the plural communication methods, and restricting and controlling implementation of automatic printing of received documents in accordance with the settings.

U.S. Patent Application Publication No. 2009/0083366, entitled SECURE DOCUMENT TRANSMISSION, published on Mar. 26, 2009, to Roantree, et al., discloses a method and apparatus which transmits an item that is in electronic form over multiple networks. The method begins by receiving the item that is to be electronically transmitted. The method separates the item into at least a first fragment and a second fragment, transmits the first fragment over a first network to a receiving device, and transmits the second fragment over a second network to the receiving device. After the receiving device receives all the different fragments, it combines the first fragment and the second fragment to reproduce the item.

U.S. Patent Application Publication No. 2009/0086277, entitled METHOD AND APPARATUS OF ADDING PAGES TO AN IMAGE DATA FILE TO BE SENT OVER A NETWORK, published on Apr. 2, 2009, to Cheshire, et al., discloses sending an image data file over a network. An image data file that includes a plurality of pages is sent from a first device to a second device, wherein at least one substitute or additional page of image data may be included in the image data file.

U.S. Pat. No. 7,623,257, entitled METHOD FOR HANDLING FAXES BY A FAX MACHINE, which issued Nov. 24, 2009, to Chase, et al., discloses a method of handling faxes by a fax machine. The method includes generating user-configured rules, each user-configured rule including a corresponding fax job condition and an associated fax machine action to be performed if the corresponding fax job condition is met. A user-configured policy is generated for handling faxes in a fax job including the user selecting the user-configured rules to be applied when the user-configured policy is applied and the user ranking the user-configured rules from a highest rank to a lowest rank. A fax machine receives a fax job and applies the user-configured policy to the fax job by applying the user-configured rules in an order of application from the highest ranked rule to the lowest ranked rule.

### BRIEF DESCRIPTION

In accordance with one aspect of the embodiments described herein, there is provided a method of processing faxes that includes receiving image data having a plurality of pages to be transmitted by a first fax device coupled to a fax transmission network and encoding page number information in a field of a fax transmission. The fax transmission, including the image data and encoded page number information, is transmitted to a second fax device coupled to the fax transmission network. The method includes determining whether all pages of the fax transmission are received, based on the transmitted page number information. When fewer than all pages of the fax transmission are received, the received pages of the image data are withheld at the second fax device. When all pages have been received, the complete image data is concatenated.

In accordance with another aspect of the embodiments described herein, a system for processing faxes includes a first fax device coupled to a fax transmission network. The first fax device includes memory which receives image data that includes a plurality of pages to be transmitted by the first fax device. An encoder component is configured to encode information, corresponding to the number of pages to be transmitted, in a field of a fax transmission. When the fax transmission, which includes the image data and encoded information, is transmitted to a second fax device coupled to the fax transmission network, the number of pages is verifiable before starting to print the image data.

In accordance with still another aspect of the embodiments described herein, a method of processing faxes receiving a fax transmission comprising a plurality of pages at a fax device coupled to a fax transmission network. Page number information and optionally sender identification information encoded in at least one sub-address field of the fax transmission id decoded. A determination is made as to whether all pages of the fax transmission are received by comparing the decoded number of pages with the received number of pages, and if so, printing the pages, otherwise, awaiting receipt of remaining pages before printing.

### BRIEF DESCRIPTION OF THE DRAWINGS

FIG. 1 is a diagrammatic view of a system including a first fax device connected by a fax transmission network to a second fax device;

FIG. 2 illustrates aspects of the system of FIG. 1 in greater detail; and

FIG. 3 is a flow chart illustrating a method for processing fax jobs in accordance with another embodiment.

### DETAILED DESCRIPTION

Embodiments herein provide systems and methods for encoding information in a fax transmission which enables a receiving fax device to determine whether all pages of an incoming fax have been received. The receiving fax device can then hold a first set of pages of the fax transmission, e.g., if the connection is broken, until the remaining pages are received. The information, which may include the document size, e.g., the number of pages being sent, and/or sender identification information, can be encoded in one or more sub-address fields which may be provided as part of a T.30 fax protocol to support transmission of information to a receiving fax device which is not to be printed, i.e., is separate from the image data being sent. The second fax machine, armed with the knowledge of where to look for the encoded information, is able to verify whether all pages have been received.

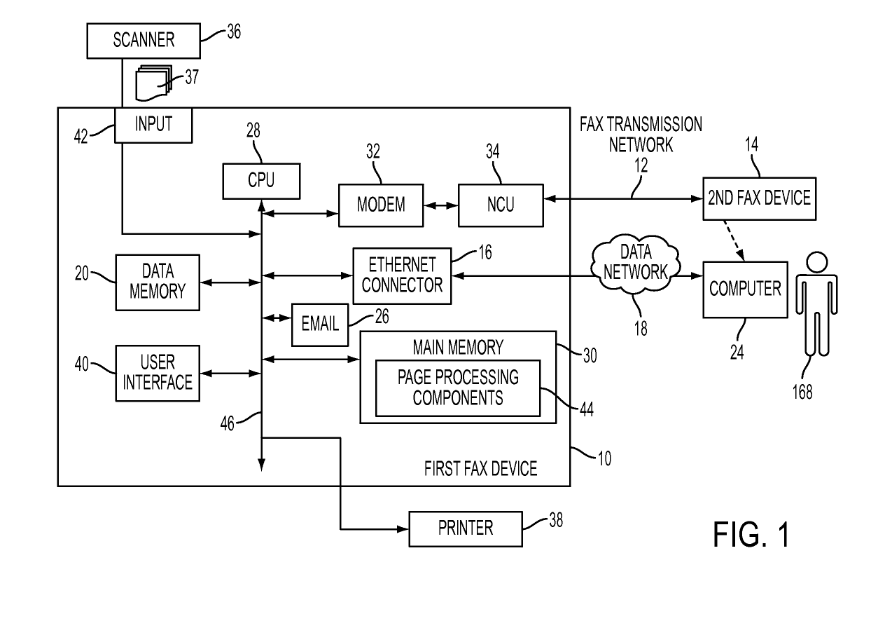

Referring to the drawings, FIG. 1 is a schematic depiction of a fax system which includes a first fax device 10. The first fax device 10 is connected to a fax transmission network (FTN) 12, for sending image data in the form of a facsimile (fax), to one or more other (second) fax device(s) 14 via the FTN 12. FTN 12 can be, for example, a Public Switched Telephone Network (PSTN), a Fax over Internet Protocol (FoIP), or other network suitable for transmission of faxes. The process of sending and/or receiving faxes is referred to herein as a fax job.

The first fax device 10 may also include a network connection 16, such as an Ethernet connection, for connecting the machine to a data transmission network 18. The network 18 may be a digital network such as a local area network (LAN), a wide area network (WAN), the Internet or Internet Protocol (IP) network, broadband networks, e.g., PSTN with broadband technology, VoiceOver IP, WiFi network, other networks or systems, or a combination of networks and/or systems.

The first fax device 10 includes data memory 20, for storing incoming faxes and for storing image data files which are to be transmitted via fax.

The fax device 10 can include email functionality 26 for sending email messages to remote computers 24, such as personal computers, via the data network 18. An electronic form of faxes can be sent over the data network 18, for example, by compressing the fax image data, converting it to a TIFF file and text-coding the TIFF file, then adding it to the data section of e-mail in accordance with such as MIME (Multipurpose Internet Mail Extensions) and transmitting/receiving it as an e-mail.

The first fax device 10 includes a or digital processor 28, such as a Central Processing Unit (CPU), for controlling the functionality of the fax device in a centralized manner, including handling fax jobs in the manner as described herein. The digital processor 28 can be variously embodied, such as by a single-core processor, a dual-core processor (or more generally by a multiple-core processor), a digital processor and cooperating math coprocessor, a digital controller, or the like.

The first fax device 10 also includes memory 30 for storing the programming suitable for carrying out fax job functions. The memories 20, 30 may represent any type of tangible computer readable medium such as random access memory (RAM), read only memory (ROM), magnetic disk or tape, optical disk, flash memory, or holographic memory. In one embodiment, the memory 30 may include a combination of random access memory and read only memory. In some embodiments, the processor 28 and memory 30 may be combined in a single chip.

The first fax device 10 also includes a modem 32 or other device suitable for connecting to the FTN 12 for sending and receiving faxes. The modem 32 is operable for modulating and demodulating a facsimile protocol signal and image signal. In the case of a PSTN network 12, a Network Coupler Unit (NCU) 34 may connect the fax device 10 to a telephone line to make an outgoing call to and receive an incoming call from a phone line in the PSTN 12 and to interface analog signals. In FoIP network, the NCU 34 is not required.

A source 36 of image data 37 is in communication with the first fax device. For example first fax device 10 can include or communicate with a scanner 36 for scanning documents to form electronic representations of the images thereof which can be sent in the form of faxes in a fax job. It is to be appreciated that the image data can be input from any suitable image source 36, such as a workstation, database, memory storage device, such as a disk, or the like. Typically each input digital image page includes image data for an array of pixels forming the image.

The first fax device 10 can also include or communicate with a printer 38 for forming printed images of received faxes, among other things, on sheet material such as paper. Suitable printers include electro-photographic printers, ink-jet printers, including solid ink printers, thermal head printers that are used in conjunction with heat sensitive paper, and other devices capable of marking an image on a substrate.

The first fax device 10 may also include a user interface 40 which can include a display screen and a control panel that enable a user to operate the fax device. The user interface 40 may provide a Graphic User Interface (GUI) displayable on the screen. The user interface 40 can be used to program the functionality of the fax device for processing faxes in the manner as described below. In other embodiments, the fax device may also be operated or programmed remotely via computer 24 connected to the fax device 12 by the data network 18.

The first fax device 10 includes an input device 42, which is configured to receive an image data file from source 36. As an alternative to a scanner, the image data can be input from any suitable image source 36, such as a workstation, database, memory storage device, such as a disk, or the like. Typically, each input digital image includes image data for an array of pixels forming the image. The image data may be photographs, video images, combined images which include photographs along with text, and/or graphics, or the like. The image data may be received in JPEG, GIF, JBIG, BMP, TIFF or other common filed format used for images and which may optionally be converted to another suitable format prior to processing. In an exemplary embodiment, the image data file comprises a plurality of pages to be transmitted by the first fax device 10.

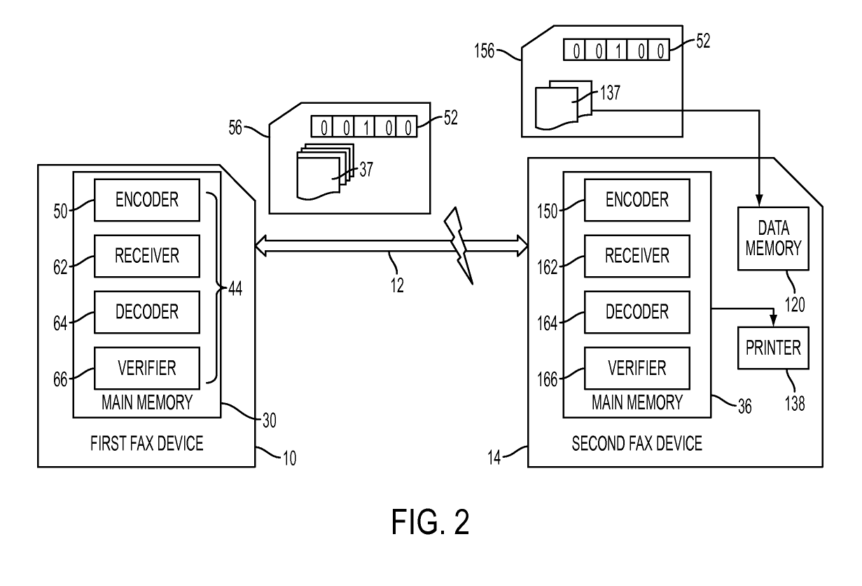

The fax device 10 includes page processing components 44, for implementing the methods described herein and which may be implemented in hardware or a combination of hardware and software. In the embodiment illustrated in FIG. 1, the components 44 are in the form of software instructions stored in memory 30, which are executed by processor 28. These components 44 are described in greater detail with reference to FIG. 2.

The various components 16, 20, 26, 28, 30, 32, 34, 48, 40, 42 of the fax device 10 may communicate via a data/control bus 46.

The second fax device 14 may be similarly configured to the first device. However, in some embodiments, the devices 10, 14 may be somewhat different. For example, the first fax device may be configured for sending but not receiving faxes. Additionally, the components 44 need not be identical.

Fax or facsimile machines disclosed herein are merely exemplary and embodiments of the disclosure may be practiced with other systems having fax capabilities (e.g., a computer, a fax server/gateway, personal digital assistant (PDA), cell phone, etc.). In addition, in an embodiment, the fax devices or first device 10 may comprise or may be part of another machine or device such as a multifunction printing device MFP or MFD) that includes multiple capabilities such as printing, scanning, faxing, and/or copying. In an embodiment, first device 10 may comprise a PC, or other device for sending and receiving faxes. Other machines and devices may also be used as long as they are capable of handling electronic image data.

The fax transmission protocol used can be any standard protocol. The International Telecommunication Union Telecommunications Standardization Sector (ITU or ITU-T), based in Geneva, Switzerland, coordinates telecommunication standards and protocols, including facsimile transmission. The ITU, for example, identifies the standards, characteristics, and operation for facsimile devices of Group 3 and Group 4 digital transmission. Group 3 (G3) fax technology is currently the most widely used type of facsimile transmission. In general, F3 fax technology uses digital modulation combined with amplitude and phase modulation of an analog signal (generated by modems). Typically data is compressed using digital compression methods and encoding is then used to communicate image data over analog telephone lines with a result of a reduced transmission time of less than one minute per page. Group 4 (G4) faxes are designed to operate over digital circuits; specifically, G4 operates on a 64 Kbps ISDN (Integrated Services Digital Network) B Channel. Unlike Group 3 faxes, the digital scan information if not converted into an analog signal, rather it is transmitted digitally.

FIG. 2 illustrates aspects of the exemplary system for processing faxes. In particular, the components 44 are shown, and some of the components of the devices 10, 14 shown in FIG. 1 are omitted for clarity. Similar components of the second fax device 14 are accorded the same numbers as for the first fax device, incremented by 100.

The first fax device 10 includes an encoder component 50, which is configured to encode information for enabling the second fax machine to determine that the entire image data of a fax transmission has been received. The second fax device 14 can include an analogous encoder component 150. The information to be encoded may include a number corresponding to the number of the pages to be sent (optionally including any cover pages). For example, if a total of four pages are to be sent, the number 4 is encoded in the field 52, e.g., as binary code. This information may be encoded in a field 52 of a fax transmission 56. The encoder component 50 may be configured to determine the number of pages to be sent, e.g., by counting the pages. The encoder component 50 may also be configured to encode sender identification information, e.g., a job identification (job ID) in the same or a different field of the fax transmission 56. In other embodiments, the job ID can be omitted and the sending machine ID, which is transmitted in the TSI signal of the fax, can be used to match parts of the fax transmission that are separated in transmission. The encoder component 50 may convert signals, T.30 data, and high-speed data for transmission over the network 12.

The field 52 used for the encoding may be a sub-address field(s). In an exemplary embodiment, the sub-address field(s) 52 is at least one of a password (PWD) field and a selective polling (SEP) field which can support identification information and can contain up to 20 digits. Rather than using them for their intended purpose, such as encoding a password or other parameters, the field 52 is used to encode page number/sender ID information. In one embodiment, the first five (or more) digits may be specified for use to encode a job ID, the next five digits (or more) can be specified for encoding the number of pages within the fax transmission, and the last ten digits can used for other purposes, such as a password.

Fax transmission 56 comprising the image data pages 37 and field information is transmitted to the second fax device 14 coupled to the fax transmission network 12. The field information is sent ahead of the pages being transmitted, so that it arrives first at the second fax device 14. If the fax transmission is broken, the field information in field 52 is resent, along with the remaining pages.

The second fax device 14 includes a receiver component 162 configured to receive the image data in a fax transmission 56, which may include a plurality of pages, and store the pages in data memory 120.

Second fax device 14 includes a decoder component 164 configured to decode encoded information in the sub-address field(s) 52 of a fax transmission 156 (here shown as a partial transmission where only two pages 137 of the original fax transmission have been received). The decoder 164 includes instructions for reading the information encoded in the sub-address field 52 and identifying therefrom, the total number of pages that the fax transmission was intended to contain. First fax device 10 can include a similar decoder component 64. The decoder 164 essentially performs a reverse process to the encoder 50, interpreting the encoding so that the original information can be retrieved. The decoder is instructed to interpret the information in the field 52 as the page number/sender information.

A verification component 166, 66 determines whether all pages of the fax transmission 56 have been received by comparing the page number information in the fax transmission filed 52 with the number of pages currently received and stored in memory 120. If the number of pages match, the fax transmission is considered to be complete. If the number of pages in memory is fewer than the number decoded form the field 52 by decoder component 164, the verification component 166 withholds the received pages of the image data at the second fax device 14 when it determines that fewer than all pages of the fax transmission 156 are received. In this case, the verification component compares sender information for a first set of the received pages with sender information for a second set of the received pages. The verification component 166 continues verifying whether all pages have been received until the number of pages stored in memory matches the number of pages transmitted, as indicated by the filed information. Once all pages have been received, the complete image data is concatenated for printing.

Second fax device 14 may email a copy of the image data of the fax transmission 56 to an email address of an intended recipient 168. Optionally, the recipient may release the complete image data for printing on printer 138. For example, the recipient may enter a password or input a key to the fax device 14 to cause the fax to be printed. Alternatively, the image data may be printed without requiring the recipient to release it.

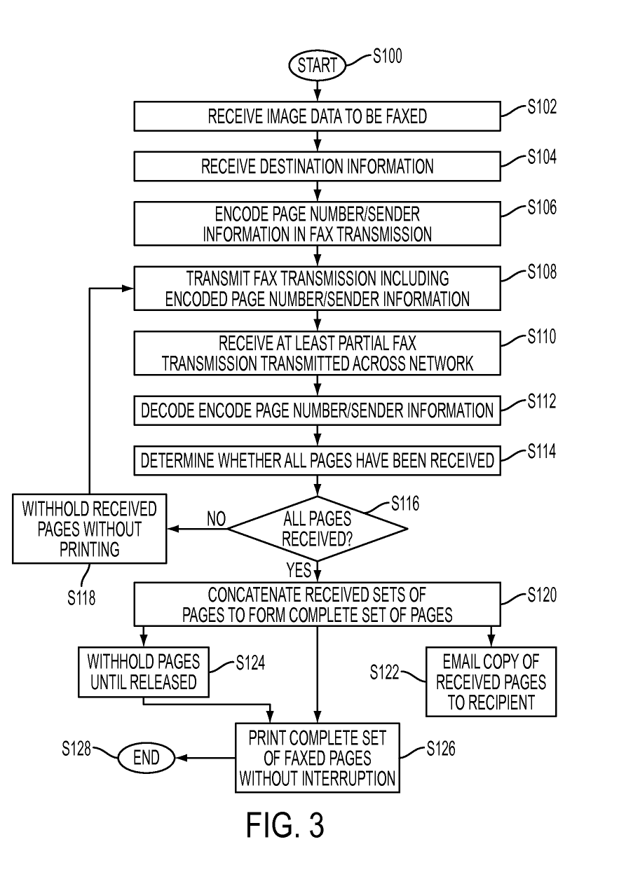

FIG. 3 is a flowchart illustrating a method 100 of processing faxes in a system such as that shown in FIGS. 1 and 2. The method begins at S100. At S102, image data comprising a plurality of pages to be transmitted, is received by the first fax device 10.

At S104, a user may be prompted to enter destination or address related information for a second fax device 14, such as its telephone number or IP address. Also at S104, the user may be prompted to enter a recipient's destination or address information. The recipient 168 is the person waiting to receive the completed fax.

At S106, page number information, including the number of pages for transmission, is encoded in a field of the fax transmission 56. Sender information, e.g. a job identification (job ID), may also be encoded for transmission in the fax transmission 56.

At S108, the fax transmission comprising the image data and field information is transmitted to the second fax device 14.

At S110, at least a partial fax transmission is received by the second fax device 14. The image data, which may comprise one or more of the pages intended to be sent, is stored in memory 120.

At S112, the number of pages to be sent is decoded from the field 52 at the second fax device 14. The number (e.g., in the illustrated example, the number 4) may be stored in memory. Additionally, the sender ID may be decoded and associated in memory with the number of pages to be received.

At S114, the number of pages actually received by the second fax device 14 is compared with the number which should have been received, as decoded from the field 52, to determine whether all pages have been received.

At S116, if from the determination at S114, fewer than all pages have been received, the method proceeds to S118, otherwise, to S120.

At S118 the received pages of the image data are withheld in memory 120 when fewer than all pages of the fax transmission are received. The verification component 166 will continue verifying when a subsequent transmission is received by comparing the sender information (sending fax device ID and/or encoded job ID) for the first set of the received pages with sender information for a second set of the received pages to determine whether the subsequent fax transmission is part of the original fax transmission and if so, incrementing the number of pages of the fax received and comparing the new number with the number of pages sent. The method may thus include repeating some or all of steps S108, S110, S112, S114, and S116.

At S120, once all the pages have been received, i.e., the number of pages received and associated with the same job ID corresponds to the number sent (as encoded in the field 52), the complete image data file is concatenated at the second fax device. The concatenation includes the bringing together, linking or otherwise connecting the first set of the received pages in order with the second set of received pages. It is to be appreciated that there may be more than two sets of received pages.

At S122, a copy of the image data of the fax transmission may be emailed to a recipient's email address by the second fax device.

Optionally at S124, the pages may be withheld until released. For example, the recipient may release the complete image data for printing. Alternatively, the image data may be printed without requiring the recipient to release it.

At S126 all the pages of the fax transmission are printed consecutively, without interruption, on the printer 138.

The method ends at S128.

The method illustrated in FIG. 3 may be implemented in a computer program product that may be executed on a computer. The computer program product may be a tangible computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use. Alternatively, the method may be implemented in a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of processing a fax that is in turn capable of implementing the flowchart shown in FIG. 3, can be used to implement the method for processing faxes.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

It will be appreciated that variants of the above-disclosed and other features and functions, or alternatives thereof, may be combined into many other different systems or applications. Various presently unforeseen or unanticipated alternatives, modifications, variations, or improvements there in may be subsequently made by those skilled in the art which are also intended to encompassed by the following claims.

What is claimed is:

1. A method of processing faxes comprising:
receiving image data comprising a plurality of pages to be transmitted by a first fax device coupled to a fax transmission network;
encoding page number information in a field of a fax transmission;
transmitting the fax transmission comprising the image data and encoded page number information to a second fax device coupled to the fax transmission network;
determining whether all pages of the fax transmission are received, based on the transmitted page number information and, where fewer than all pages of the fax transmission are received, withholding the received pages of the image data at the second fax device; and
when all pages have been received, concatenating complete image data.

2. The method of claim 1, further comprising encoding sender identification information in the field of the fax transmission.

3. The method of claim 2, wherein the determining includes comparing the sender information for a first set of the received pages with sender information for a second set of the received pages.

4. The method of claim 1, wherein the field in which the number of pages is encoded is a sub-address field.

5. The method of claim 4, wherein the sub-address field is at least one of a password (PWD) field and a selective polling (SEP) field.

6. The method of claim 1, wherein at least one of the first fax device and the second fax device comprises a multi-function device.

7. The method of claim 1, further comprising printing the complete image data.

8. The method of claim 1, wherein the network is selected from the group consisting of a local area network (LAN), a wide area network (WAN), a fax over internet protocol (FoIP) network, a PSTN, a WiFi network, and a combination thereof.

9. The method of claim 1, wherein the encoding is performed by a processor of the first fax device.

10. A computer program product comprising tangible media which encodes instructions for performing the method of claim 1.

11. A system for processing faxes comprising:
a fax device comprising memory which stores instructions for performing the method of claim 1 and a processor, in communication with the memory for executing the instructions.

12. A system for processing faxes comprising:
a first fax device coupled to a fax transmission network including:
memory for receiving image data comprising a plurality of pages to be transmitted by the first fax device; and
an encoder component configured to encode information, corresponding to a number of pages to be transmitted, in a field of a fax transmission, whereby when the fax transmission comprising the image data is transmitted to a second fax device coupled to a fax transmission network, the number of pages is verifiable before starting to print the image data.

13. The system of claim 12, wherein the encoder component is in the form of software instructions stored in memory and which are executed by a processor of the first fax device.

14. The system of claim 11, wherein the encoder component is configured to encode sender identification information in a field of the fax transmission.

15. The system of claim 11, further comprising a second fax device coupled to the fax transmission network comprising a decoder component configured to decode the number of pages encoded in the field of the fax transmission.

16. The system of claim 15, wherein the second fax comprises a verification component configured to compare the number of pages encoded in the field with a number of pages received, and if the number received is less than the encoded number, to withhold printing of the received pages.

17. The system of claim 11, wherein at least one of the first fax device and the second fax device comprises a multi-function device.

18. The system of claim 11, further comprising a printer associated with the second fax device for printing the complete image data.

19. The system of claim 11, wherein the network is selected from the group consisting of a local area network (LAN), a wide area network (WAN), a fax over internet protocol (FoIP) network, a PSTN, a WiFi network, and a combination thereof.

20. A method of processing faxes comprising:
receiving a fax transmission comprising a plurality of pages at a fax device coupled to a fax transmission network;
decoding page numbers and optionally sender identification information encoded in at least one sub-address field of the fax transmission; and
determining whether all pages of the fax transmission are received, by comparing the decoded number of pages with the received number of pages, and if so, printing the pages, otherwise, awaiting receipt of remaining pages before printing.

21. The method of claim 20, wherein the sub-address field is at least one of a password (PWD) field and a selective polling (SEP) field.

22. The method of claim 20, further comprising:
encoding the number of pages in the sub-address field of the fax transmission; and
transmitting the fax transmission comprising the plurality of pages and encoded page number to the fax device.

23. A computer program product comprising tangible media which encodes instructions for performing the method of claim 20.
